(19) United States
(12) Patent Application Publication
(10) Pub. No.: US 2024/0241768 A1
(43) Pub. Date: Jul. 18, 2024

(54) PRIORTY-BASED SCHEDULING METHOD AND SCHEDULER PERFORMING THE METHOD

(71) Applicant: ELECTRONICS AND TELECOMMUNICATIONS RESEARCH INSTITUTE, Daejeon (KR)

(72) Inventors: Jongtae SONG, Daejeon (KR); Daeub KIM, Daejeon (KR)

(21) Appl. No.: 18/224,860

(22) Filed: Jul. 21, 2023

(30) Foreign Application Priority Data
Jan. 12, 2023 (KR) 10-2023-0004960

(51) Int. Cl. G06F 9/50; G06F 9/54

(52) U.S. Cl. CPC G06F 9/5077; G06F 9/546; G06F 2209/5021; G06F 2209/548

(57) ABSTRACT

A priority-based scheduling method and a scheduler configured to perform the method are disclosed. The priority-based scheduling method performed by a host of a memory separation network includes receiving a traffic load of queues divided according to priorities from a distributed memory configured to perform a load monitoring function, updating a throttle value of the queues divided according to the priorities at regular intervals, selecting a queue to transmit a request to the distributed memory from among all the queues divided according to the priorities, and adjusting a bandwidth of the selected queue by using the throttle value when the request of the selected queue is transmitted to the distributed memory.

### CROSS-REFERENCE TO RELATED APPLICATION(S)

This application claims the priority benefit of Korean Patent Application No. 10-2023-0004960 filed on Jan. 12, 2023, in the Korean Intellectual Property Office, the disclosure of which is incorporated herein by reference for all purposes.

### BACKGROUND

### 1. Field of the Invention

One or more embodiments relate to a priority-based scheduling method, and more specifically, to a priority-based Quality-of-Service (QOS) control method required when distributing memory operated in a datacenter server.

### 2. Description of Related Art

A cloud computing structure has been evolving from homogeneous computing in which central processing unit (CPU) performance is important to heterogeneous computing in which fast data exchange between specialized engines is important. With the evolution to the heterogeneous computing, a network of the datacenter has been developing from a structure of connecting servers to a disaggregation technology for connecting cloud resources, such as a CPU, memory, an accelerator, or storage.

An issue related to the disaggregation technology of computing resources is to prevent application performance from decreasing by accelerating a connection between resources while distributing the resources. An ultimate goal is to provide a bandwidth and latency of the connection between the resources physically at the same server level. Performance degradation does not occur in the accelerator or the storage because the required bandwidth and connection latency may be satisfied even when a resource pool is configured by using a power switch. The memory requires a 100-gigabits per second (Gbps) bandwidth and 1-microseconds (μs) connection latency to minimize performance degradation, which may not be secured by a power switch, and the application of an optical switch may be necessary. In particular, an optical connection is expected to be required to support a high bandwidth memory (HBM) requiring several terabits per second (Tbps).

In addition, the usage rate of the memory and the CPU of the current datacenter is not sufficient, and after measuring a usage rate of a memory and a CPU of an actual datacenter, the respective memory/CPU usage rates of servers have as much as a thousand-fold difference. For example, an imbalance in resource use is severe with only 2-percent (%) application using 98% of the resources, which leads the resource usage rate of the current datacenter to linger at around 40%.

To solve the problem, a memory disaggregation technology using an optical switch, beyond the current storage-level disaggregation technology, is demanded.

### SUMMARY

An aspect provides a method and device for preventing the traffic of a high priority from being blocked before the traffic of a low priority is blocked when a traffic load increases by performing scheduling by reflecting a throttle value differentiated according to priorities.

However, technical aspects are not limited to the foregoing aspect, and there may be other technical aspects.

According to an aspect, there is provided a priority-based scheduling method performed by a host of a memory separation network including receiving a traffic load of queues divided according to priorities from a distributed memory configured to perform a load monitoring function; updating a throttle value of the queues divided according to the priorities at regular intervals by using the received traffic load; selecting a queue to transmit a request to the distributed memory from among all the queues divided according to the priorities; and adjusting a bandwidth of the selected queue by using the throttle value when the request of the selected queue is transmitted to the distributed memory.

The traffic load may be calculated by counting cases of the number of requests recorded in each of the queues divided according to the priorities of the distributed memory exceeding a preset comparison standard, and the preset comparison standard may include a greater value as distance latency between the host and the distributed memory increases.

The traffic load may increase a count value even when a queue of a lower priority exceeds the preset comparison standard when a queue of a higher priority is counted and may be calculated through a percentage obtained by dividing the count value of each of the queues divided according to the priorities by a total count value.

The selecting may include determining whether a bandwidth size corresponding to each of all the queues divided according to priorities is greater than or equal to a certain standard; determining whether there is a request to be processed with respect to at least one queue having a bandwidth size that is greater than or equal to the certain standard; and selecting a queue having a highest priority from the at least one queue determined to have the request to be processed as a queue to transmit a request to the distributed memory.

The selecting may include increasing a bandwidth by using the throttle value for a queue to which a corresponding bandwidth is less than the certain standard of all the queues divided according to the priorities, in which the increased bandwidth is reflected on a next scheduling time.

The bandwidth of the selected queue may be updated by subtracting a throttle value corresponding to the selected queue from the bandwidth.

According to another aspect, there is provided a priority-based scheduling method performed by a host of a memory separation network including receiving a traffic load of queues divided according to priorities from a distributed memory configured to perform a load monitoring function; updating a throttle value of the queues divided according to the priorities at regular intervals by using the received traffic load; determining whether the host transmits a request to the distributed memory in an order from the highest priority; and updating a bandwidth for a queue of which a priority is lower than a priority of the queue determined to transmit the request.

The traffic load may be calculated by counting cases of the number of requests recorded in each of the queues divided according to the priorities of the distributed memory exceeding a preset comparison standard, and the preset comparison standard may include a greater value as distance latency between the host and the distributed memory increases.

The traffic load may increase a count value even when a queue of a lower priority exceeds the preset comparison standard when a queue of a higher priority is counted and may be calculated through a percentage obtained by dividing the count value of each of the queues divided according to the priorities by a total count value.

The determining may include determining whether to transmit a request by each of the queues divided according to the priorities, based on whether each of the queues includes a request to be processed and a size of a bandwidth corresponding to each of the queues.

The determining may further include transmitting a request to be processed to the distributed memory when there is the request to be processed and a size of a bandwidth corresponding to each of the queues is greater than or equal to a certain standard by each of the queues divided according to the priorities and determining whether to transmit a request by a queue having a lower priority than a queue when the queue does not comprise the request to be processed or a size of a bandwidth corresponding to the queue is less than the certain standard.

The determining may further include increasing a bandwidth by using the throttle value for a queue to which a corresponding bandwidth is less than the certain standard of all the queues divided according to the priorities, in which the increased bandwidth is reflected on a next scheduling time.

The bandwidth of the queue determined to transmit the request may be updated by subtracting a throttle value corresponding to the determined queue from the bandwidth.

According to another aspect, there is provided a scheduler of a host configured to perform a priority-based scheduling method including one or more processors and a memory configured to load or store a program executed by the one or more processors, in which the program includes receiving a traffic load of queues divided according to priorities from a distributed memory configured to perform a load monitoring function; updating a throttle value of the queues divided according to the priorities at regular intervals; selecting a queue to transmit a request to the distributed memory from among all the queues divided according to the priorities; and adjusting a bandwidth of the selected queue by using the throttle value when the request of the selected queue is transmitted to the distributed memory.

The traffic load may be calculated by counting cases of the number of requests recorded in each of the queues divided according to the priorities of the distributed memory exceeding a preset comparison standard, and the preset comparison standard may include a greater value as distance latency between the host and the distributed memory increases.

The traffic load may increase a count value even when a queue of a lower priority exceeds the preset comparison standard when a queue of a higher priority is counted and may be calculated through a percentage obtained by dividing the count value of each of the queues divided according to the priorities by a total count value.

The one or more processors may determine whether a bandwidth size corresponding to each of all the queues divided according to the priorities is greater than or equal to a certain standard, determine whether there is a request to be processed with respect to at least one queue having a bandwidth size that is greater than or equal to the certain standard, and select a queue having a highest priority from the at least one queue determined to have the request to be processed as a queue to transmit a request to the distributed memory.

The one or more processors may increase a bandwidth by using the throttle value for a queue to which a corresponding bandwidth is less than the certain standard of all the queues divided according to the priorities, wherein the increased bandwidth is reflected on a next scheduling time.

The bandwidth of the selected queue may be updated by subtracting a throttle value corresponding to the selected queue from the bandwidth.

According to another aspect, the traffic of a high priority may be prevented from being blocked before the traffic of a low priority is blocked when a traffic load increases by performing scheduling by reflecting a throttle value differentiated according to priorities.

Additional aspects of example embodiments will be set forth in part in the description which follows and, in part, will be apparent from the description or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating a priority-based scheduling system in a memory separation network, according to an embodiment;

FIG. 2 is a diagram illustrating a method of measuring a traffic load according to an embodiment;

FIG. 3 is a diagram illustrating a method of updating a throttle value by using a traffic load for a queue of a priority i, according to an embodiment;

FIG. 4 is a diagram illustrating an example of a priority-based scheduling method according to an embodiment;

FIG. 5 is a diagram illustrating another example of the priority-based scheduling method according to an embodiment;

FIG. 6 is a diagram illustrating an example of another priority-based scheduling method according to an embodiment;

FIG. 7 is a diagram illustrating an application result of the priority-based scheduling method according to an embodiment; and

FIG. 8 is a diagram illustrating a configuration of a scheduler according to an embodiment.

### DETAILED DESCRIPTION

The following detailed structural or functional description is provided as an example only and various alterations and modifications may be made to embodiments. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

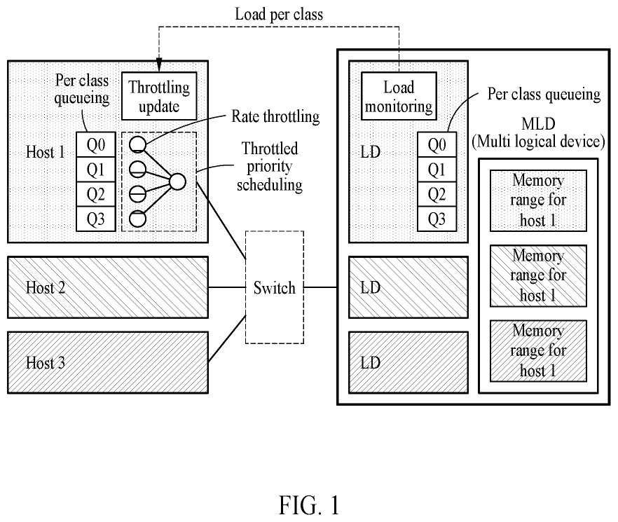

FIG. 1 is a diagram illustrating a priority-based scheduling system in a memory separation network, according to an embodiment.

A memory disaggregation technology has been developing in a multi-logical device (MLD) form, in which a plurality of hosts shares memory resources. The MLD may divide an address of a logical device (LD) into a range, and each of the plurality of hosts may use a memory resource corresponding to the LD by using the address of the LD divided into the range. In this case, the plurality of hosts may be connected to the MLD to be implemented in various forms.

The present disclosure may provide a method of scheduling by determining a priority according to an application service when the plurality of hosts accesses a distributed memory included by the MLD. In this case, the present disclosure may further provide flow control for providing a priority-based scheduling method at both ends of the MLD and the plurality of hosts.

Referring to FIG. 1, an LD of an MLD and a host may have a per class queuing structure for transmitting and receiving a request by each class. The LD of the MLD may include a load monitoring function for monitoring a traffic load of the per class queuing structure and may transmit a traffic load value monitored through the load monitoring function to the host.

The host may include a throttling update function for updating a bandwidth for memory access by using the traffic load value transmitted from the LD and a throttled priority scheduling function for performing scheduling based on a throttle value updated through the throttling update function.

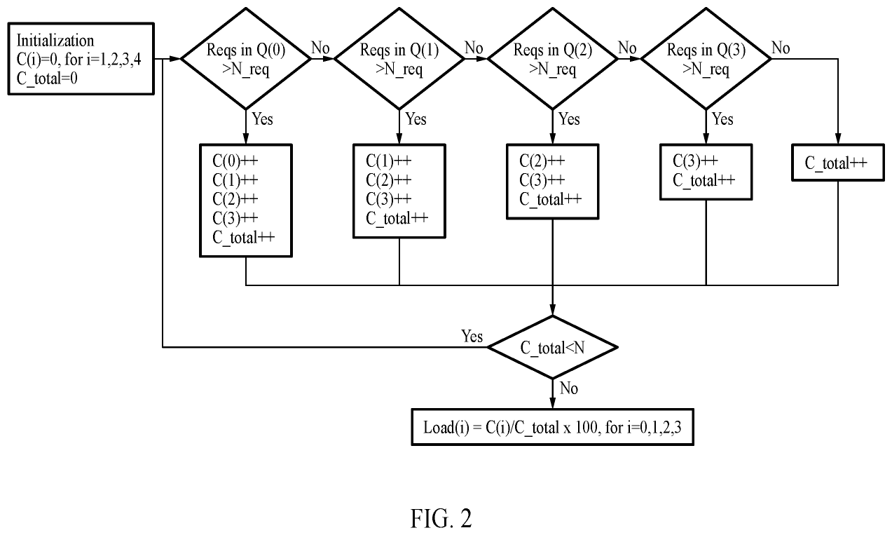

FIG. 2 is a diagram illustrating a method of measuring a traffic load according to an embodiment.

FIG. 2 illustrates the method of measuring a traffic load for four queues divided according to priorities by using a load monitoring function included by each LD included by an MLD. In this case, load monitoring may be periodically performed, and N queue states are assumed to be measured at every interval (e.g., hundreds of nanoseconds (nsec)).

An LD may monitor a traffic load for each of the four queues divided according to the priorities. In this case, a queue of a priority i may be represented by Q(i), and a traffic load for the queue of the priority i may be measured based on a state of Q(i).

The LD may measure the traffic load for the queue of the priority i by comparing the number of requests in Q(i) with a preset comparison standard N_req. More specifically, the LD may calculate a value of a priority counter C(i) by counting cases in which there may be traffic when the number of requests in Q(i) is greater than the preset comparison standard N_req. In this case, the LD may calculate the value of the priority counter C(i) for the priority i by summing traffic loads of lower priorities.

For example, when Q(0) corresponding to the highest priority, that is, Priority 0, is greater than the preset comparison standard N_req, the LD may increase all priority counters C(0), C(1), C(2), and C(3). On the other hand, when Q(3) corresponding to the lowest priority, that is, Priority 3, is greater than the preset comparison standard N_req, the LD may only increase the priority counter C(3).

The LD may calculate a traffic load Load(i) for the queue of the priority i at every interval according to Equation 1 below, and Load(i)<Load(j) may be always satisfied when i<j according to this algorithm.

$$Load ( i ) = \frac{C ( i )}{C total} \times 100$$

In this case, N_req may have a value greater than 1 and may prevent a traffic load of traffic of a high priority from sharply decreasing by having a greater value as distance latency between a host and a distributed memory increases.

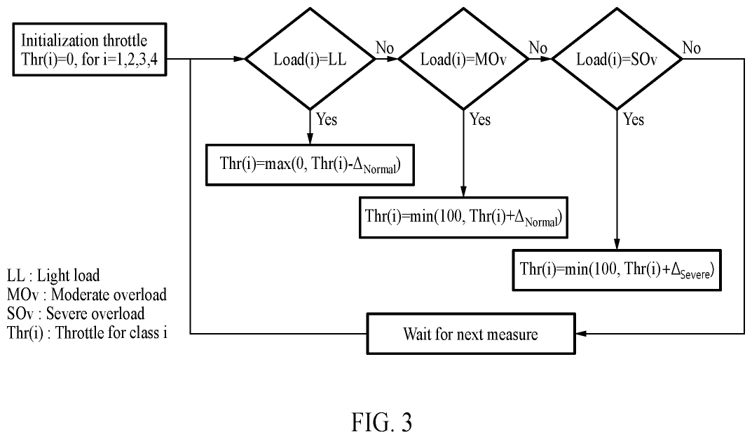

FIG. 3 is a diagram illustrating a method of updating a throttle value by using a traffic load for a queue of a priority i, according to an embodiment.

A host may update a throttle value Thr(i) of the priority i by using a traffic load of each priority provided by an LD through a throttling update function. The throttle value Thr(i) of the priority i may increase or decrease based on a traffic load Load(i) that is periodically provided by the LD. In this case, the throttle value Thr(i) may have a value from 0 to 100. When the throttle value Thr(i) is 0, the host may use a bandwidth 100% for the queue of the priority i. And when the throttle value Thr(i) is 100, the host may use the bandwidth 0% for the queue of the priority i.

The host may adjust the throttle value Thr(i) by a Δ_{Normal} Or Δₛₑᵥₑᵣₑ value (Δ_{Normal}<Δₛₑᵥₑᵣₑ) by dividing a traffic load level into a light load (LL) level, an optimal load (OL) level, a moderate overload (MOv) level, and a severe overload (SOv) level. When the traffic load level is the SOv level, the host may increase the throttle value Thr(i) by Δₛₑᵥₑᵣₑ. On the other hand, when the traffic load level is the MOv level or the LL level, the host may increase or decrease the throttle value Thr(i) by Δ_{Normal}.

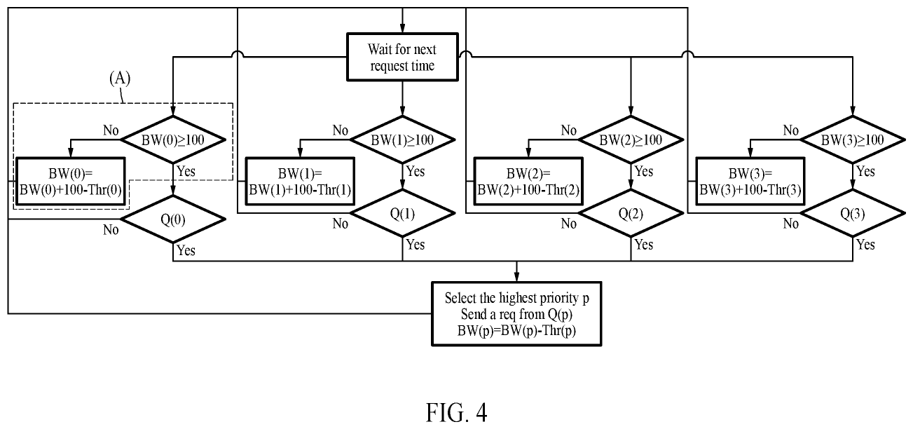

FIG. 4 is a diagram illustrating an example of a priority-based scheduling method according to an embodiment.

As described above, a host may include a throttled priority scheduling function for performing scheduling based on a throttle value updated through a throttling update function, and the throttled priority scheduling function may be executed specifically by a scheduler included in the host.

More specifically, the scheduler may determine whether a bandwidth size corresponding to a queue is greater than or equal to a certain standard for all queues divided according to the priorities at every interval. Then, the scheduler may determine whether there is a request to be processed with respect to at least one queue having a bandwidth size that is greater than or equal to the certain standard. The scheduler may select a queue having the highest priority from the at least one queue determined to have the request to be processed as a queue to transmit a request to a distributed memory.

For example, referring to FIG. 4, when the size of a bandwidth BW(0) corresponding to a queue corresponding to Priority 0 is less than 100, a scheduler may determine that a bandwidth is yet to be sufficient, may increase the size of the bandwidth BW(0) by 100-Thr(i), and may return to a next sequence.

On the other hand, when the size of the bandwidth BW(0) corresponding to the queue corresponding to Priority 0 is greater than or equal to 100, the scheduler may determine whether a queue Q(i), that is, the queue corresponding to Priority 0, has a request to be processed. When determining that Q(i) does not have the request to be processed, the scheduler may return to a next scheduling sequence, and when determining that Q(i) has the request to be processed, the scheduler may determine Q(i) to be a candidate queue to transmit the request to be processed.

The scheduler may perform such a candidate queue determination method on all queues corresponding to the priority i, may select Q(p) corresponding to a priority p that is the highest priority of Q(i) determined to be the candidate queue, and may transmit the request.

When scheduling is performed once as such, the scheduler may adjust a BW(p) value by subtracting a throttle value Thr(p) from a bandwidth BW(p) of Q(p) having transmitted the request and the adjusted BW(p) value may be reflected on a next scheduling time.

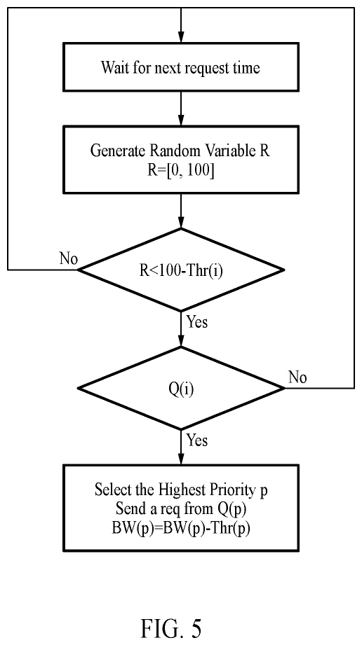

In this case, a portion A in which the scheduler determines BW(i)=100 may include a method of stochastically implementing a percentage 100-Thr(i) as illustrated in FIG. 5. More specifically, the scheduler may generate a random variable R having a distribution from 0 to 100 as illustrated in FIG. 5 and may proceed to an operation of checking a state of Q(i) when an R value is less than 100-Thr(i). On the other hand, when the random variable R is greater than 100-Thr(i), the scheduler may not use a BW(i) value and may wait for a next request without updating BW(i).

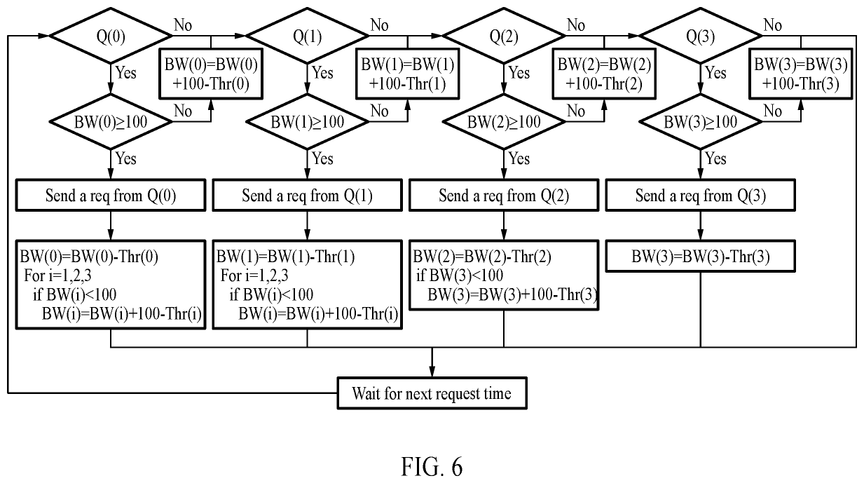

FIG. 6 is a diagram illustrating an example of another priority-based scheduling method according to an embodiment.

The priority-based scheduling method described with reference to FIGS. 4 and 5 may cause starvation in a queue of a lower priority because of a method of selecting a queue of the highest priority after parallel processing. To solve the problem, the present disclosure may provide a method of sequentially performing scheduling from a queue of the highest priority to a queue of the lowest priority.

More specifically, a scheduler may determine whether to transmit a request by each of the queues divided according to the priorities, based on whether each of the queues includes a request to be processed and the size of a bandwidth corresponding to each of the queues. In this case, the scheduler may transmit a request to be processed to a distributed memory when each of the queues includes the request to be processed and the size of the bandwidth corresponding to each of the queues is greater than or equal to a certain standard by each of the queues divided according to the priorities and may determine whether to transmit a request by a queue having a lower priority than a queue when the queue does not include the request to be processed or a size of a bandwidth corresponding to the queue is less than the certain standard.

For example, referring to FIG. 6, when Q(0), that is, a queue corresponding to Priority 0, does not include a request, the scheduler may move to an operation of determining whether Q(1), that is, a queue corresponding to Priority 1, includes a request.

On the other hand, when Q(1) corresponding to Priority 1 does not include the request, the scheduler may determine whether the size of a bandwidth BW(0) corresponding to Q(0) is greater than or equal to 100. When the size of the bandwidth BW(0) is less than 100, the scheduler may increase the size of the bandwidth BW(0) by 100-Thr(i), and then may move to the operation of determining whether Q(1), that is, the queue corresponding to Priority 1, includes the request.

On the other hand, when the size of the bandwidth BW(0) is greater than or equal to 100, the scheduler may select Q(0) as a queue to transmit the request and may transmit the request included in Q(0) to a distributed memory. When scheduling is performed on Q(0) as such, the scheduler may adjust a BW(0) value by subtracting a throttle value Thr(0) from the bandwidth BW(0) of Q(0) having transmitted the request and the adjusted BW(0) value may be reflected on a next scheduling time.

Then, the scheduler may update a bandwidth for a queue of a lower priority that is not selected and may prevent the possible starvation of the queue of the lower priority. The scheduler may repeatedly perform such a scheduling method onto Q(3), that is, a queue of the lowest priority.

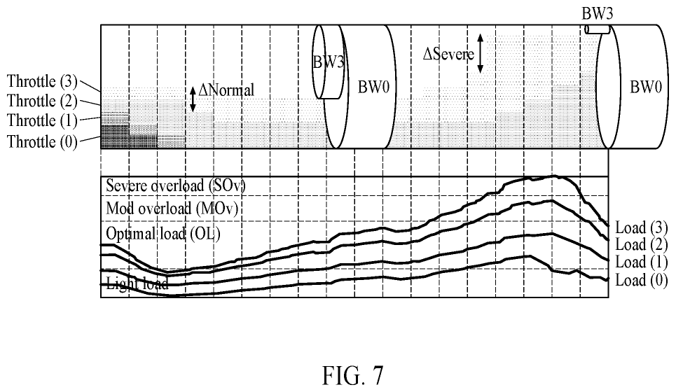

FIG. 7 is a diagram illustrating an application result of the priority-based scheduling method according to an embodiment.

When applying the priority-based scheduling method of the present disclosure, a throttle value may be differentiated according to priorities. Accordingly, this method may solve the problem of traffic of a higher priority being blocked before traffic of a lower priority is blocked when a traffic load increases.

Referring to FIG. 7, even when the level of a traffic load is high, a high level of a bandwidth BW0 may be provided for Priority 0, which is the highest priority. In addition, for Priority 3, which is the lowest priority, a bandwidth BW3 is maintained at a minimum level in an SOv state, but a relatively sufficient level of the bandwidth BW3 may be provided in an LL state, which may increase the utilization of a whole system.

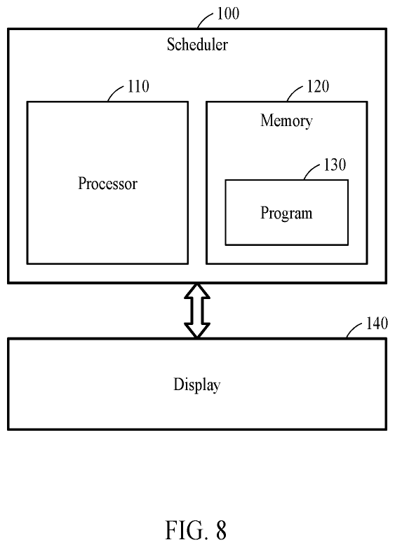

FIG. 8 is a diagram illustrating a configuration of a scheduler according to an embodiment.

Referring to FIG. 8, a scheduler 100 may include one or more processors 110 and a memory 120 for loading or storing a program 130 performed by the one or more processors 110. The components included in the scheduler 100 of FIG. 8 are just an example, and one of ordinary skill in the art may understand that other generally used components may be further included besides the components illustrated in FIG. 8.

The one or more processors 110 may control an overall operation of each of the components of the scheduler 100. The one or more processors 110 may include at least one of a central processing unit (CPU), a microprocessor unit (MPU), a microcontroller unit (MCU), a graphics processing unit (GPU), a neural processing unit (NPU), a digital signal processor (DSP), and other well-known types of processors in a relevant field of technology. In addition, the one or more processors 110 may perform an operation of at least one application or program to perform the methods/operations described herein according to embodiments. The scheduler 100 may include one or more processors.

The memory 120 may store one of or two or more combinations of various pieces of data, commands, and pieces of information that are used by the components (e.g., the one or more processors 110) included in the scheduler 100. The memory 120 may include a volatile memory or a non-volatile memory.

The program 130 may include one or more actions through which the methods/operations described herein according to embodiments are implemented and may be stored in the memory 120 as software. In this case, an operation may correspond to a command that is implemented in the program 130. For example, the program 130 may include receiving a traffic load of queues divided according to priorities from a distributed memory configured to perform a load monitoring function; updating a throttle value of the queues divided according to the priorities at regular intervals; selecting a queue for transmitting a request to the distributed memory from among all the queues divided according to the priorities; and adjusting a bandwidth of the selected queue by using the throttle value when the request of the selected queue is transmitted to the distributed memory.

When the program 130 is loaded in the memory 120, the one or more processors 110 may execute a plurality of operations to implement the program 130 and perform the methods/operations described herein according to embodiments.

An execution screen of the program 130 may be displayed through a display 140. Although the display 140 is illustrated as being a separate device connected to the scheduler 100 in FIG. 8, the display 140 may be included in the components of the scheduler 100 when the scheduler 100 is a smartphone, a tablet, or other terminals that are portable by a user. The screen displayed on the display 140 may be a state before the information is input to the program 130 or may be an execution result of the program 130.

The examples described herein may be implemented by using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A priority-based scheduling method performed by a host of a memory separation network, the priority-based scheduling method comprising:
receiving a traffic load of queues divided according to priorities from a distributed memory configured to perform a load monitoring function;
updating a throttle value of the queues divided according to the priorities at regular intervals by using the received traffic load;
selecting a queue to transmit a request to the distributed memory from among all the queues divided according to the priorities; and
adjusting a bandwidth of the selected queue by using the throttle value when the request of the selected queue is transmitted to the distributed memory.

2. The priority-based scheduling method of claim 1, wherein
the traffic load is calculated by counting cases of the number of requests recorded in each of the queues divided according to the priorities of the distributed memory exceeding a preset comparison standard, and
the preset comparison standard comprises a greater value as distance latency between the host and the distributed memory increases.

3. The priority-based scheduling method of claim 2, wherein
the traffic load increases a count value even when a queue of a lower priority exceeds the preset comparison standard when a queue of a higher priority is counted, and
is calculated through a percentage obtained by dividing the count value of each of the queues divided according to the priorities by a total count value.

4. The priority-based scheduling method of claim 1, wherein the selecting comprises:
determining whether a bandwidth size corresponding to each of all the queues divided according to priorities is greater than or equal to a certain standard;
determining whether there is a request to be processed with respect to at least one queue having a bandwidth size that is greater than or equal to the certain standard; and
selecting a queue having a highest priority from the at least one queue determined to have the request to be processed as a queue to transmit a request to the distributed memory.

5. The priority-based scheduling method of claim 4, wherein the selecting comprises:
increasing a bandwidth by using the throttle value for a queue to which a corresponding bandwidth is less than the certain standard of all the queues divided according to the priorities, wherein
the increased bandwidth is reflected on a next scheduling time.

6. The priority-based scheduling method of claim 1, wherein
the bandwidth of the selected queue is updated by subtracting a throttle value corresponding to the selected queue from the bandwidth.

7. A priority-based scheduling method performed by a host of a memory separation network, the priority-based scheduling method comprising:
receiving a traffic load of queues divided according to priorities from a distributed memory configured to perform a load monitoring function;
updating a throttle value of the queues divided according to the priorities at regular intervals by using the received traffic load;
determining whether the host transmits a request to the distributed memory in an order from a highest priority; and
updating a bandwidth for a queue of which a priority is lower than a priority of the queue determined to transmit the request.

8. The priority-based scheduling method of claim 7, wherein
the traffic load is calculated by counting cases of the number of requests recorded in each of the queues divided according to the priorities of the distributed memory exceeding a preset comparison standard, and
the preset comparison standard comprises a greater value as distance latency between the host and the distributed memory increases.

9. The priority-based scheduling method of claim 8, wherein
the traffic load increases a count value even when a queue of a lower priority exceeds the preset comparison standard when a queue of a higher priority is counted, and
is calculated through a percentage obtained by dividing the count value of each of the queues divided according to the priorities by a total count value.

10. The priority-based scheduling method of claim 7, wherein the determining comprises:
determining whether to transmit a request by each of the queues divided according to the priorities, based on whether each of the queues comprises a request to be processed and a size of a bandwidth corresponding to each of the queues.

11. The priority-based scheduling method of claim 10, wherein the determining further comprises:
transmitting a request to be processed to the distributed memory when there is the request to be processed and a size of a bandwidth corresponding to each of the queues is greater than or equal to a certain standard by each of the queues divided according to the priorities; and
determining whether to transmit a request by a queue having a lower priority than a queue when the queue does not comprise the request to be processed or a size of a bandwidth corresponding to the queue is less than the certain standard.

12. The priority-based scheduling method of claim 11, wherein the determining further comprises:
increasing a bandwidth by using the throttle value for a queue to which a corresponding bandwidth is less than the certain standard of all the queues divided according to the priorities, wherein
the increased bandwidth is reflected on a next scheduling time.

13. The priority-based scheduling method of claim 7, wherein
a bandwidth of the queue determined to transmit the request is updated by subtracting a throttle value corresponding to the determined queue from the bandwidth.

14. A scheduler of a host configured to perform a priority-based scheduling method, the scheduler comprising:
one or more processors; and
a memory configured to load or store a program executed by the one or more processors, wherein the program comprises:
receiving a traffic load of queues divided according to priorities from a distributed memory configured to perform a load monitoring function; updating a throttle value of the queues divided according to the priorities at regular intervals; selecting a queue to transmit a request to the distributed memory from among all the queues divided according to the priorities;
and adjusting a bandwidth of the selected queue by using the throttle value when the request of the selected queue is transmitted to the distributed memory.

15. The scheduler of claim 14, wherein
the traffic load is calculated by counting cases of the number of requests recorded in each of the queues divided according to the priorities of the distributed memory exceeding a preset comparison standard, and
the preset comparison standard comprises a greater value as distance latency between the host and the distributed memory increases.

16. The scheduler of claim 15, wherein
the traffic load increases a count value even when a queue of a lower priority exceeds the preset comparison standard when a queue of a higher priority is counted, and
is calculated through a percentage obtained by dividing the count value of each of the queues divided according to the priorities by a total count value.

17. The scheduler of claim 14, wherein the one or more processors are configured to
determine whether a bandwidth size corresponding to each of all the queues divided according to priorities is greater than or equal to a certain standard, determine whether there is a request to be processed with respect to at least one queue having a bandwidth size that is greater than or equal to the certain standard, and select a queue having a highest priority from the at least one queue determined to have the request to be processed as a queue to transmit a request to the distributed memory.

18. The scheduler of claim 17, wherein the one or more processors are further configured to
increase a bandwidth by using the throttle value for a queue to which a corresponding bandwidth is less than the certain standard of all the queues divided according to the priorities, wherein the increased bandwidth is reflected on a next scheduling time.

19. The scheduler of claim 14, wherein
the bandwidth of the selected queue is updated by subtracting a throttle value corresponding to the selected queue from the bandwidth.
